(19) United States
(12) Patent Application Publication
(10) Pub. No.: US 2025/0181933 A1
(43) Pub. Date: Jun. 5, 2025

(54) NEURAL NETWORK PROCESSING

(71) Applicant: Arm Limited, Cambridge (GB)

(72) Inventor: Elliot Maurice Simon Rosemarine, London (GB)

(21) Appl. No.: 18/525,413

(22) Filed: Nov. 30, 2023

(51) Int. Cl. G06N 3/10

(52) U.S. Cl. CPC G06N 3/10

(57) ABSTRACT

A data processing system, the data processing system comprising a processor that is configured to perform neural network processing, the processor comprising: at least one execution unit configured to perform processing operations for neural network processing; and a control circuit configured to distribute processing tasks to the at least one execution unit to cause the at least one execution unit to perform processing operations for neural network processing in response to a set of indications of neural network processing to be performed provided to the control circuit; wherein the processing tasks are asynchronous and comprise a dependency on at least one other processing task, the set of indications of neural network processing to be performed comprising an indication flag to indicate whether the execution unit can be caused to operate with a dependency on at least one other asynchronous processing task being unresolved.

Certain data processing techniques, such as neural network processing and graphics processing, involve the processing and generation of considerable amounts of data. When a neural network model is being executed, the execution process is typically broken down into smaller tasks or jobs, which can include tasks such as matrix multiplications, convolutions and other operations involved in neural network computations.

There typically exists data dependencies within jobs that the neural engine or graphics processor is designed to perform. These dependencies can lead to stalls when an instruction or other unit of work is dependent on the result of a previous instruction or other unit of work that has not yet been completed and can increase the time taken to get working on new jobs until the dependencies have been resolved. The inventors have recognized that much of this latency is caused by the fetching of neural network processing data structures that describe data such as tensor and weight descriptors, thereby delays in fetching so-called metadata or program/structural data and an inability to overlap execution of jobs. The inventors have also recognized that tasks are sometimes stalled in respect of their sending to the Neural engine if dependencies have not been resolved.

A first aspect of present techniques allows for early fetching of neural network processing data structures and for overlap of job execution within a neural engine even if dependencies have not been resolved.

According to a first aspect of present techniques, a data processing system comprises a processor that is configured to perform neural network processing, the processor comprising at least one execution unit configured to perform processing operations for neural network processing; and a control circuit configured to distribute processing tasks to the at least one execution unit to cause the at least one execution unit to perform processing operations for neural network processing in response to a set of indications of neural network processing to be performed provided to the control circuit; wherein the processing tasks are asynchronous and comprise a dependency on at least one other processing task, the set of indications of neural network processing to be performed comprising an indication flag to indicate whether the execution unit can be caused to operate with a dependency on at least one other asynchronous processing task being unresolved.

According to a second aspect of present techniques, there is provided a method of operating an execution unit of a processor that is configured to perform neural network processing, the method comprising: receiving a task and a set of indications of neural network processing to be performed; detecting from at least a first indication flag in the set of indications whether the neural network processing for the task can be started with at least one unresolved dependency at the execution unit; detecting from at least a second flag which neural network processing work items of the task can be performed at the execution unit with at least one unresolved dependency; performing the execution unit processing operations for neural network processing; detecting when the at least one unresolved dependency becomes resolved; and responsive to detecting when the at least one unresolved dependency becomes resolved, completing the neural network processing for the task.

A third aspect of present techniques allows for getting tasks sent to a Neural Engine earlier even if dependencies have not been resolved.

According to a third aspect of present techniques there is provided a data processing system, the data processing system comprising a command processing unit and a processor that is configured to perform processing, the processor comprising: multiple execution units configured to perform processing operations for a type of work; and a control circuit configured to distribute processing tasks to the multiple execution units to cause the multiple execution units to perform processing operations for the type of work in response to asynchronous commands provided to the control circuit by the command processing unit; wherein dependency tracking is compared against an array of counters to indicate dependencies within the array of counters; wherein the indicated dependencies are provided to the control circuit by the command processing unit in the asynchronous commands to indicate for the type of work that dependencies have been resolved or that dependencies exist.

According to a fourth aspect of present techniques, there is provided a method of data processing, the data processing method implemented by a command processing unit and a processor that is configured to perform processing, the method comprising: processing operations for a type of work; distributing processing tasks to multiple execution units to cause the multiple execution units to perform processing operations for the type of work in response to asynchronous commands provided to the control circuit by the command processing unit; tracking dependency through comparison against an array of counters to indicate dependencies within the array of counters; providing the indicated dependencies to the control circuit by the command processing unit in the asynchronous commands and indicating for the type of work that dependencies have been resolved or that dependencies exist.

Generally speaking, neural network processing requires various, particular arithmetic operations. For example, when applying a filter to an input data array, the processing may comprise performing weighted sums according to a “multiply accumulate” (MAC) operation. Typically the data structures used to represent the data to be used for the neural network processing (e.g. the input data array, the filters, the output data array, etc.) are tensors. The arithmetic operations thus typically comprise tensor arithmetic, e.g. tensor multiplication, addition, and so on.

To facilitate neural network processing, in some data processing systems a dedicated neural network processing hardware accelerator (e.g. neural processing unit, NPU) is provided as a hardware accelerator that is operable to perform such neural network processing as and when desired, e.g. in response to an application that is executing on a host processor (e.g. central processing unit (CPU)) requiring neural network processing.

Such a neural network processing hardware accelerator typically comprises hardware (for example comprising fixed function processing circuits) which is configured for more efficiently performing neural network processing operations of a particular type or types. For example, a neural accelerator may be, and typically is, configured to perform tensor arithmetic operations, such as tensor MAC operations, and may therefore comprise a plurality of fixed function multiplier accumulator circuits (“MAC units”) which are arranged to perform such MAC operations on tensor data structures.

A benefit of providing a neural accelerator is therefore that at least these types of arithmetic operations can then be performed in a more optimised manner, e.g. using dedicated fixed function hardware circuitry, compared to using another processor (e.g. the CPU) to perform the calculations in a general purpose manner. This also then frees up other components (e.g. the host processor (CPU)) to perform other processing tasks, as desired, which may improve the overall processing efficiency. This can be particularly important for resource constrained devices, such as mobile devices, where the CPU resource may be limited.

In such data processing systems, the, e.g. host processor (CPU) will be operable to request the neural accelerator to perform a set of neural network processing operations, for example for an application executing on the host processor (CPU). A driver for the neural accelerator can then identify and determine the neural network processing to be performed, and indicate to the neural accelerator the appropriate operations, and data, for performing the desired neural network processing.

The processor that is configured to perform neural network processing in the present invention can be any suitable and desired processor that is configured to perform neural network processing, e.g., and preferably, that includes processing circuits configured specifically to perform (to more optimally perform) processing operations of a type or types that will (e.g. more commonly) be required for neural network processing. In a preferred embodiment, the processor that is configured to perform neural network processing is a neural network processing hardware accelerator (engine).

The processor configured to perform neural network processing comprises one or more execution units, each configured to perform a processing operation or operations for neural network processing. The processor may comprise any suitable and desired number of such execution units.

Each execution unit is preferably configured to perform a particular, preferably selected, preferably determined, type or types of processing operation that are (e.g. more commonly) encountered during neural network processing (and preferably in an efficient, and preferably more optimal, manner), such as a particular, e.g., tensor, arithmetic operation, and preferably comprises appropriate, preferably fixed function, processing circuits for performing the operation or operations in question. For example, there may be an execution unit that is configured to (and comprises fixed function processing circuits configured to) perform multiply accumulate (MAC) operations.

The particular operations that the neural network processor (its execution unit(s)) is configured to perform can be any suitable and desired processing operations that are used for (and useful for) neural network processing.

The processor that is configured to perform neural network processing preferably comprises an (arithmetic) execution unit or units that is configured to (more optimally) perform arithmetic operations, such as, and preferably, tensor arithmetic operations, e.g. of a certain type, that will be more commonly encountered during neural network processing.

In a preferred embodiment the processor comprises, inter alia, an execution unit configured to apply a filter to an input data array and preferably to perform a weighted sum using input data and weight data. In a particularly preferred embodiment, the execution unit(s) is configured to perform a weighted sum as a multiply-accumulate operation, and accordingly comprises one or more multiply-accumulate circuits (otherwise known as a multiplier-accumulator, or an “MAC unit”) for performing a multiply-accumulate operation.

In a particularly preferred embodiment, the processor that is configured to perform neural network processing comprises at least an execution unit that is configured to perform convolution like arithmetic operations (a fixed function convolution unit), preferably together with one or more other, preferably fixed-function, execution units which are configured to perform other (arithmetic) operations.

In a preferred embodiment the processor that is configured to perform neural network processing comprises one or more of, and preferably plural of, the following execution units: direct memory access units (e.g. to read/write tensors) (and which may include a compression and decompression unit); a weight decode fetches weights and may also include a decompression unit; one or more transform units, e.g. for rearranging data without any effect from the value of individual elements in the data, such as permuting dimensions, duplicating/broadcasting dimensions, inserting/removing dimensions or rearranging data order; one or more elementwise operation units, such as to perform arithmetic operations such as addition, multiplication, etc., logical operations (shifts, etc.), and/or bitwise operations; execution units to perform clamping (ReLU), scaling and/or zero point correction, lookup tables; one or more execution units to perform reduction operations, such as sum, min/max, argmax, argmin, etc.; one or more execution units to perform resize operations, such as scaling H/W dimensions, inserting zeros, replicating neighbours or bilinear filtering.

It would also be possible to have execution units that are able to perform plural of the above operations, such as a vector engine able to implement elementwise reduction and resize, for example.

Other arrangements would, of course, be possible.

The processor that is configured to perform neural network processing also includes a control circuit that is configured to distribute processing tasks to the execution unit or units of the neural processor to cause the execution units to perform processing operations for neural network processing.

Again, this control circuit can take any suitable and desired form, and should be, and is preferably, operable to schedule corresponding processing tasks for, and on, the execution unit or units of the neural network processor in response to an indication of neural network processing to be performed provided to the control circuit. For example, in response to a given indication of neural network processing to be performed, the control circuit may schedule a corresponding processing task for an arithmetic execution unit of the processor, e.g. to cause the (arithmetic) execution unit to perform a tensor arithmetic operation for the neural network processing.

In a preferred embodiment, the control circuit is also operable to and configured to be able to, subdivide an overall neural network processing task to be performed into smaller, sub tasks, such as, and preferably, respective blocks of neural network processing, for distribution to the execution unit or units of the neural processor (or to the graphics processor, in accordance with the present invention).

For instance, in some embodiments, the neural network processing involves subdividing the processing of an initial input data array into one or more, and preferably a plurality of, blocks/sub blocks. The control unit of the processor that is configured to perform the neural network processing may then cause the execution unit(s) to execute the neural network processing operations for the blocks/sub blocks, and preferably one after another, until the sequence of operations has been completed for the entire initial input data array. This may be done in any suitable and desired manner.

In a preferred embodiment, the control circuit of the processor that is configured to perform neural network processing is operable to transform a first, e.g., and preferably, multi-dimensional, iteration (operation) space that processing work is defined with respect to, to a respective (different) iteration space of an execution unit of the neural processor that is to perform the processing operation in question, or of the programmable execution unit of the graphics processor, as appropriate.

It will be appreciated in this regard that neural network processing is typically higher dimensional, at least 4D, but the neural execution units may perform operations of various dimensionality, for example from 2D up to 8D. The work to the execution units is despatched to the execution units using their appropriate dimensionality, while iterating through the overall higher dimensional operation space.

In a preferred embodiment, the control circuit operates in this regard so as to subdivide an overall, common iteration/operation space to generate respective blocks of that space for distributing for processing, with a respective transformation of each individual block to the iteration/operation space for an execution unit then being performed (as and when required). Correspondingly, in the case where a neural network processing task requires the use of multiple operations (multiple execution units) each block in the common iteration/operation space will undergo the appropriate transformation for each execution unit (operation) that it is to be processed by. This will then allow each block that an execution unit sees to relate back to a consistent and common set of blocks from (in) the common iteration/operation space.

As well as the neural network processing operation execution unit or units and the control circuit, the processor that is configured to perform neural network processing may contain any other suitable and desired components, units and elements, etc., e.g., and preferably, that a neural network processor may normally include.

In a preferred embodiment, the neural processor is operable to, and includes one or more processing circuits (units) configured to and operable to, access a memory system and (main) memory of the data processing system, e.g., and preferably, so as to be able to read data from, and write data to, memory of the data processing system. Such memory access units can take any suitable and desired for, and preferably comprise one or more direct memory access (DMA) units (circuits) associated with (of) the processor which is to perform the neural network processing. Correspondingly, the data processing system preferably comprises (e.g. main) memory that is operable to and used to store data for neural network processing and that is external to the processor that is performing the neural network processing, e.g. main memory, and that is, preferably, accessed from and by the processor that is configured to perform neural network processing via an appropriate memory access unit or units, and preferably via one or more direct memory access (DMA) units, e.g., and preferably, via a cache hierarchy (a cache system) of the overall memory system.

In a particularly preferred embodiment, the neural processor includes local storage, preferably in the form of one or more buffers, that is local to the processor that is configured to perform neural network processing and intended and used for storing data locally while an execution unit or units are performing neural network processing. This can be, and is preferably, used to store tensor data, weight data, etc.

This local storage should be, and is preferably, physically (and logically) separate from any (main) memory of the data processing system, and should be, and is preferably, storage that is internal to the processor that is performing the neural network processing and/or that can be accessed by execution unit(s) of the neural processor directly (without the need for a memory access unit (e.g. DMA) and not via any bus interface (in contrast to the (main) memory)).

Reference to a graphics processor in the present invention can be any suitable and desired graphics processor that includes a programmable execution unit operable to execute (shader) programs to perform processing operations. The graphics processor may otherwise be configured and operable as desired, and be configured to execute any suitable and desired form of graphics processing pipeline (in its normal graphics processing operation).

The programmable execution unit of the graphics processor may be any suitable and desired such execution unit, such as, and preferably, an appropriate execution engine of an execution core of the graphics processor. Thus, the programmable execution unit of the graphics processor is preferably part of and comprised in an appropriate (shader) execution (processing) core of the graphics processor. The graphics processor may comprise a single programmable execution unit (and execution core), or plural execution units (and execution cores), as desired.

The graphics processor (its execution core(s)), may, for example, and preferably, comprise further components and units necessary for the execution of (shader) programs, such as, for example, and preferably, local storage for storing data for use by execution threads when the execution unit is executing a (shader) program, preferably in the form of a register file, and a load/store unit (circuit) operable to load and store data for use (e.g. from memory to the local storage (register file) and from the local storage to memory), when executing a program.

The graphics processor preferably also comprises an appropriate control unit (circuit) that is operable to, and configured to, control the execution of programs to perform processing operations by the execution unit of the graphics processor. Most preferably, this control unit is in the form of an appropriate thread group (warp) manager that is operable to create (spawn) groups of execution threads for execution, and schedule and control the execution of (shader) programs by such groups of threads by the programmable execution unit.

The processing operations that are performed by the execution of a program by the graphics processor can be any suitable and desired processing operations that may be required for neural network processing. They are preferably operations that are not (directly and explicitly) supported by the neural processor, such as, and preferably, operations that cannot be performed by an execution unit of the neural processor.

The processor that is configured to perform neural network processing and the graphics processor may be distinct and separate processing units, such that the data processing system will comprise a stand alone graphics processing unit (GPU) and a stand alone neural processing unit (NPU).

In a preferred embodiment, the submission of processing work for the graphics processor and neural processor is controlled using “command” stream(s), that may, for example, include commands (instructions) to set parameters for processing jobs, as well as commands (instructions) to execute the processing jobs. Such command streams may be generated by a host processor and written to appropriate command stream storage, e.g. in (main) system memory, and then read therefrom for processing.

Correspondingly the system preferably includes one or more “command stream frontends”, e.g., and preferably, each comprising a “command stream execution unit”, for interpreting and implementing the command streams.

A command stream execution unit may, for example, work its way through a command stream, executing, in turn, the commands (instructions) in the command stream and causing the operations indicated by the commands to be performed.

There could in this regard be separate frontend control units (command stream frontends) for the graphics processor and the neural processor, respectively, but in a particularly preferred embodiment, there is common (shared) frontend control unit (command stream frontend) that is operable to receive commands from an, e.g., host processor, and in response to those commands then distribute processing tasks respectively to a (shader) execution core or cores of the graphics processor or to the neural processor (e.g. neural engine of the graphics processor) accordingly and as appropriate.

In this case therefore, the common, shared frontend control unit (command stream frontend) will identify commands relating to neural network processing, and then distribute such commands (or the work required for those commands) to the control unit of the processor that is configured to perform neural network processing (of the neural engine), for that control unit to then cause the neural processor (the neural engine) to perform the necessary neural network processing, and, correspondingly, for non neural network related graphics processing tasks, correspondingly identify commands relating to graphics processing tasks and distribute those tasks appropriately to a control unit (e.g. thread group manager) of an execution core or cores of the graphics processor for those tasks to thereby be performed.

It should be noted here that such a command stream frontend (command stream execution unit) will accordingly be, and is preferably, distinct from and separate to the control unit of the neural processor that distributes processing tasks to execution units of the neural processor (or to the graphics processor), and correspondingly to the corresponding control unit (e.g. thread group (warp) manager) of the graphics processor.

Most preferably, the command stream frontend (command stream execution unit) is provided with higher level commands indicative of processing tasks to be performed, and then provides those tasks appropriately to the control unit of the neural engine or of the graphics processor, for those control units to then distribute the particular processing tasks necessary to the appropriate execution units and to schedule the performance of those processing tasks on the execution units.

Thus there will, in effect, and preferably, be a suitable control unit, preferably in the form of a command stream frontend, that receives indications of processing tasks to be performed from an, e.g. host processor, and that in response to those commands distributes processing tasks to the control units of the individual processors (the graphics processor and the neural processor), as appropriate, with those control units (circuits) of the individual processors then causing the processing tasks to be performed appropriately (as discussed above).

In the present invention, the control circuit of the neural processor is operable to distribute processing tasks to the execution unit or units of the neural processor (or, alternatively, to the graphics processor) in response to respective indications of processing operations for neural network processing to be performed provided to the control circuit.

The indications of neural network processing to be performed that are provided to the control circuit of the neural processor can take any suitable and desired form. They should, and preferably do, at least indicate the (neural network) processing operation or operations to be performed, the relevant input data (input data arrays) to be used for the respective processing operations (such as respective input feature maps, sets of weights, etc.), where any output data (output data arrays (output feature maps)) of a processing operation is to be stored, and any other parameters (e.g. state) necessary for performing the processing operation or operations in question.

This information can be provided to the control circuit of the neural processor in any suitable and desired form. For example, an appropriate set of commands and other, e.g. state, information that conveys this information and the operations to be performed could be conveyed to and provided to the control unit of the neural processor.

In a particularly preferred embodiment, the indications of the neural network processing to be performed are in the form of one or more sets of neural network processing information, preferably in the form of one or more neural network processing data structures (descriptors) (in memory), with each such set of information (descriptor) preferably indicating a sequence of one or more processing operations to be performed for the neural network processing, an indication of the data inputs and outputs (e.g., and preferably, where the data is to be read from and stored to) for each operation in the sequence indicated by the set of information (descriptor), and an indication of the location in memory of the initial input to the sequence of operations and/or of where the output from the sequence of operations should be stored (in memory).

The indications of the operations to be performed can indicate any suitable and desired operations that may be required to be performed when performing neural network processing using the neural processor. It is preferably possible to indicate a requirement to perform one or more of, preferably plural of, and preferably all of, the following operations: reads from memory; writes to memory; and any of the operations for which there is a particular (fixed function) execution unit in the neural processor, such as a convolution operation or any of the other neural network processing operations discussed above. The indications of neural network processing to be performed may also, and preferably do also, indicate the size of the space (the iteration space) that the neural network processing is to be performed over.

The information indicating the operations to be performed can convey any suitable and desired information for defining the operation(s) that is to be performed. They preferably indicate at least the type of operation to be performed, any necessary attributes or parameters for that operation, the location of any inputs and/or outputs for the operation, and the “iteration” space over which the operation is to be performed.

The information indicating the location of the inputs and outputs for the processing operations for the neural network processing can correspondingly take any suitable and desired form. In the case where an input or output relates to (main) memory of the data processing system, the information preferably comprises suitable information for locating the data in memory, such as an indication of a memory address where the data is stored/is to be stored, an indication of the layout that the data will have in the memory, an indication of the size of the data in memory, and/or an indication of the type of the data in question.

In a preferred embodiment, in particular in the case where, as discussed above, the neural processor includes its own local storage that can, in effect, be used independently of the (main) system memory when performing neural network processing, an indication of the location of input and output data for a processing operation can indicate an appropriate location for that data within the local storage of the neural processor (rather than in (main) memory).

Thus, in a particularly preferred embodiment, an indication of neural network processing to be performed can indicate that input data for a processing operation should be retrieved from the local storage of the neural processing (and where in the local storage of the neural processor that data should be retrieved from), and correspondingly that output data from a processing operation should be stored in the local storage of the neural processor (and where in the local storage of the neural processor that output data should be stored). Such “local storage” indications preferably identify a set of local storage data, which set of data is then otherwise defined, e.g. by an appropriate descriptor for the set of data.

In a preferred embodiment, there can be a set (sequence) of plural such sets of neural network processing information (descriptors), which are, e.g., and preferably, acted upon in turn by the control unit of the neural processor to cause the desired neural network processing operations to be performed.

The indications of the neural network processing to be performed that are provided to the control unit of the neural processor can be prepared in any suitable and desired manner. In a particularly preferred embodiment the necessary indications of neural network processing to be performed are generated from a higher level, e.g. graph based, description of the neural network processing to be performed, preferably by means of an appropriate compilation process. Thus, a higher level, e.g. graph based, description of neural network processing to be performed is compiled into an appropriate “lower level” set of indications of neural network processing to be performed (e.g. one or more neural network processing descriptors as discussed above), that can then be appropriately interpreted and used by the control unit of the neural processor to trigger and control the necessary neural network processing. Thus, the preparation of the indications of neural network processing to be performed is preferably done by a compiler for the neural processor, which compiler may, e.g., and in an embodiment, be executed on an appropriate processor (e.g. CPU) of a data processing system (e.g. of the data processing system that the neural processor is part of, or of a separate data processing system, as desired).

The compilation process may be, and is preferably, performed in advance of any execution and performing of the neural network processing itself, in an “offline” manner. Thus (at least some of) the compilation process is preferably done in advance of runtime, rather than at runtime for the neutral network in question. Correspondingly, (at least some of) the compilation process and compiler preferably executes separately and in advance of running the driver (the driver operation for the processor that is to perform the neural network processing).

Thus, in a preferred embodiment, the compiler operation will prepare in advance the indications of neural network processing to be performed, and then, for example, and preferably, store those indications (e.g. neural processing descriptors) for future use.

Then, e.g., at runtime, the, e.g., driver, will identify and determine the neural network processing to be performed (e.g. based on a request for neural network processing, e.g. from an application requiring neural network processing, e.g. executing on a host processor (CPU) of the data processing system), and issue an appropriate command or commands that will cause the control unit of the neural processor to access the appropriate indications of neural network processing to be performed and then cause that neural network processing to be appropriately performed.

Thus, in a preferred embodiment, the indications of neural network processing to be performed are provided to the control unit of the neural processor by storing those indications appropriately in memory, with the indications then being retrieved appropriately from memory by the control unit of the neural processor and acted upon accordingly, when the desired neural network processing is to be performed.

In a preferred embodiment, the compilation process and the compiler is also configured to, and operates to, prepare and store any associated data structures necessary for the neural network processing (and to include in the indications of neural network processing to be performed, appropriate indications of those data structures).

Thus, in a preferred embodiment, any appropriate data structures, e.g., comprising the desired input feature maps and/or weight arrays (filters) to be used for the neural network processing are also prepared and, e.g., and preferably, stored appropriately in memory. Correspondingly, appropriate indications of the locations of the required data structures are preferably also generated.

Depending upon the nature of the data structures and the data and, e.g., whether it can be generated in an “offline” manner in advance, or will only be known/available at runtime, such data structures may be generated and/or stored in advance, in an “offline” manner, or they may, e.g., be generated and/or stored, e.g., and preferably, by the driver, at runtime, e.g. as a just in time process, as appropriate. Thus, for example, and preferably, as well as at least some of the indications of neural network processing to be performed being able to be and being generated in advance, in an “offline” manner, there may be at least some indications of neural network processing to be performed that are generated at runtime, e.g., and preferably, by the driver for the neural processor.

When neural network processing is required, the control unit of the neural processor can be triggered to, e.g., read the necessary indications of neural network processing to be required from memory (and to then process those indications) in any suitable and desired manner. Particularly in the case where there is a frontend control unit (a command stream frontend) that is operable to distribute processing tasks to the control unit of the neural processor, this is achieved by including an appropriate command in the sequence of commands (in the command stream) that is provided to the frontend control unit (the command stream frontend), e.g. such as a “run neural network of a particular type” command, in response to which the frontend control unit (command stream frontend) will indicate to the control unit of the neural processor the particular neural network processing to be performed (e.g. where it should read the relevant indications of the neural network processing to be performed from, with the control unit then reading the relevant neural network processing indications and operating accordingly).

In this case therefore, and preferably, the, e.g., and preferably, driver for the neural processor will recognise a request for particular neural network processing to be performed, and include in the command stream that is provided to the command stream frontend for the neural processor, an appropriate command or commands indicating that required neural network processing.

Other arrangements would, of course, be possible. As well as the processor configured to perform neural network processing and the graphics processor, the data processing system may otherwise comprise any desired components and elements that a data processing system can comprise, such as one or more or all of: a display processing unit (display processor), one or more central processing units (CPU), a video processor, a digital signal processor, a display and a memory.

The processors may be arranged within a system-on-chip system.

The data processing system may be implemented as part of any suitable electronic device which may be required to perform neural network processing, e.g., such as a desktop computer, a portable electronic device (e.g. a tablet or mobile phone), or other electronic device. Thus the present invention also extends to an electronic device that includes the data processing system of the present invention (and on which the data processing system operates in the manner of the present invention). The data processing system of the present invention may, in an embodiment, be implemented as part of a portable electronic device (such as a mobile phone, tablet, or other portable device).

The present techniques may be used in conjunction with and for any suitable and desired neural network and neural network processing. In preferred embodiments, the neural network is a convolutional neural network.

In embodiments, the neural network processing may relate to an “inferencing” or “classification” process. However, there are various different types or arrangements of neural networks that may be used to perform different operations, as desired, and the present invention may find utility in any suitable such applications. The present invention may also be used during a training process.

The input for the neural network processing may correspond to (or be derived from) any suitable data which is received by the data processing system for processing according to neural network processing in order to generate a useful output such as, for example, an image, an image from an Image Signal Processor (ISP), an image frame from video data, sound data or voice data, or other input data. Correspondingly the neural network processing which is to be performed may contribute to identifying or classifying features present within the data (initially) received by the data processing system, e.g. such as objects in an input image, or sound features in input sound data. Alternatively, the neural network processing which is to be performed may contribute to training the neural network.

A number of preferred embodiments of the present invention will now be described by way of example only and with reference to the accompanying drawings, in which:

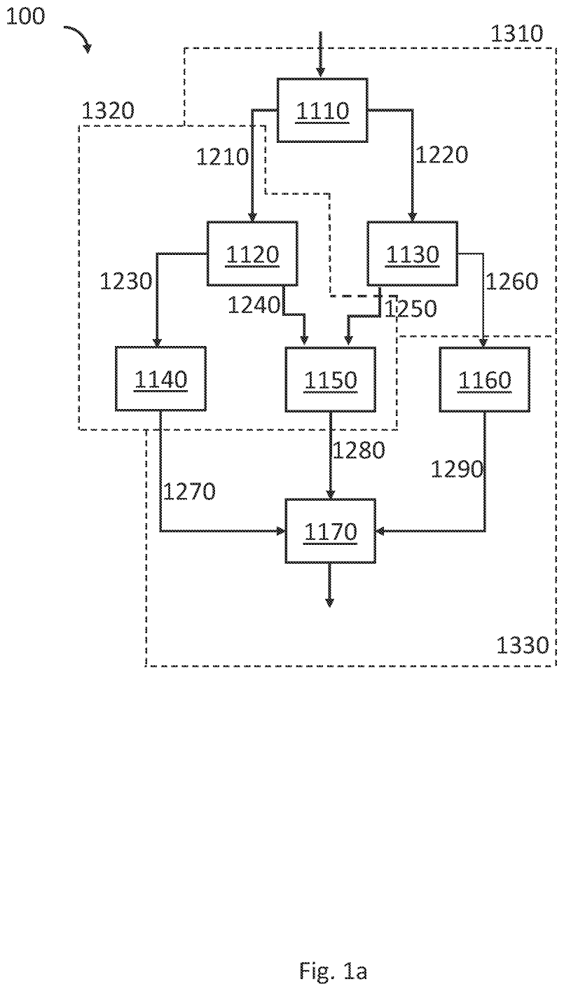

FIG. 1a illustrates an example directed acyclic graph according to the present disclosure;

FIG. 1b illustrates schematically an example of a data processing system according to the present disclosure;

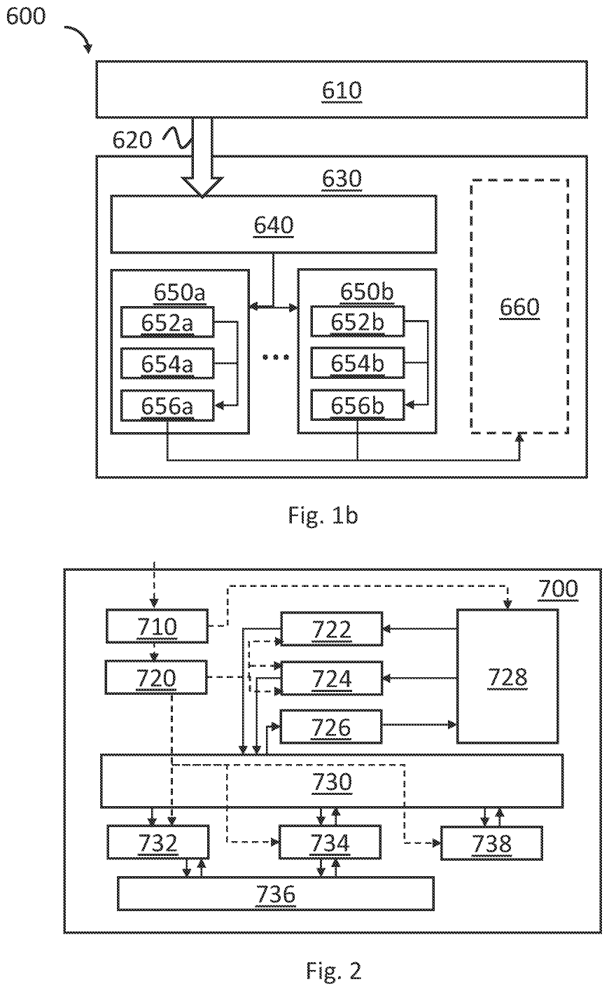

FIG. 2 illustrates a schematic diagram of a neural engine according to the present disclosure;

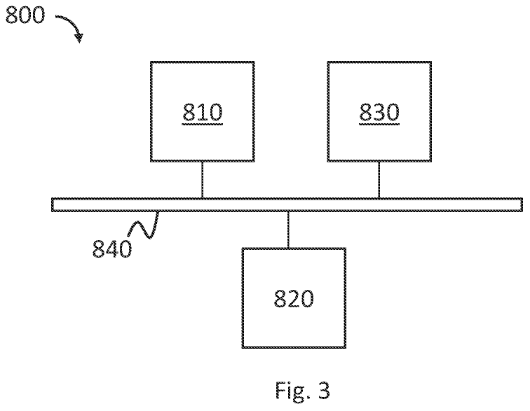

FIG. 3 illustrates schematically an example system for allocating handling data according to the present disclosure; and

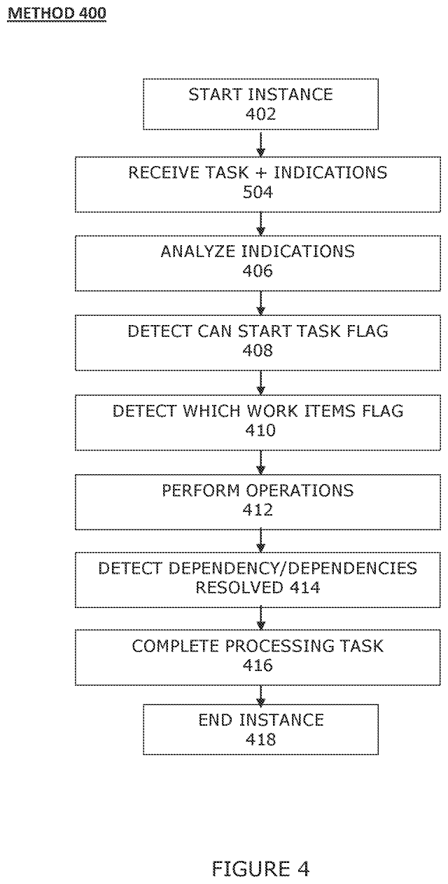

FIG. 4 shows in a much simplified form a method of operation according to the present disclosure.

Many data structures to be executed in a processor can be expressed as a directed acyclic graph. Examples of such data structures include neural networks which can be represented as a directed acyclic graph of operations that wholly compose the operations required to execute a network (i.e. to executed the operations performed across the layers of a neural network). A directed acyclic graph is a data structure of operations (herein also referred to as ‘sections’) having directed connections therebetween that indicate a flow of operations such that those directed connections do not form a closed loop. The connections between operations (or sections) present in the graph of operations are also to referred herein as ‘pipes’. An acyclic graph may contain any number of divergent and convergent branches.

FIG. 1a illustrates an example directed acyclic graph 100 in which sections are interconnected by a series of pipes. Specifically, an initial section, section 1 (1110) represents a point in the acyclic graph at which an operation, operation A, is to be performed when executing the graph. The output of operation A at section 1, 1100, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the acyclic graph may receive multiple inputs, each from a respective different section in the acyclic graph via a respective different pipe. For example, section 1150 in FIG. 1a receives a first set of input data via pipe 1240 from section 1120 and a second set of input data via pipe 1250. Depending on the nature of the operation performed in a particular section and the dependencies of subsequent operations on the output of the operation, any number of input and output pipes may be connected to a particular section in the acyclic graph.

The acyclic graph can be represented by a number of sub-graphs each containing a subset of the sections in the graph. FIG. 1a illustrates an arrangement where the graph 110 is broken down into three sub-graphs 1310, 1320, and 1330 which can be connected together to form the complete graph. For example, sub-graph 1310 contains sections 1110 and 1130 (as well as the corresponding pipes 1220 and 1260), sub-graph 1320 contains sections 1120, 1140, and 1150 (as well as corresponding pipes 1210, 1230, 1240 and 1250), and sub-graph 1330 contains sections 1160 and 1170 (as well as corresponding pipes 1270, 1280 and 1290).

The deconstruction of a graph 100 into sub-graphs is particularly useful when seeking to execute the graph since it would be possible to separately execute the sub-graphs which allows for parallelization of execution where there are no dependencies between sub-graphs. This can be particularly useful in a multi-processor environment where sub-graphs can be allocated for execution by different processors in the multi-processor environment. However, as shown in FIG. 1a sub-graph 1320 has a dependency on the execution of operation A and section 1110 and sub-graph 1330 has a dependency on sub-graph 1310. As such, execution of sub-graph 1330 may need to be stalled until sub-graph 1310 has been completed.

It will therefore be appreciated that it is necessary to carefully select the appropriate sub-graph arrangement to maximise or improve the execution efficiency of the graph. Moreover, it is advantageous to minimize any stalling for sub-graphs that do not have dependencies so that their execution is not held up waiting for dependencies in other sub-graphs to be completed.

The operations performed when executing a neural network can be broken down into a sequence of operations forming an acyclic graph in the form described in respect of FIG. 1a. The detailed description herein will describe an arrangement for executing an acyclic graph of operations in an improved manner.

As described above, a data structure in the form of a directed acyclic graph may comprise plural sequenced operations that are connected to one another for execution in a chain. Described below is an example hardware arrangement for executing chained operations for at least a portion of a directed acyclic graph as illustrated in FIG. 1a.

FIG. 1b shows schematically an example of a data processing system 600 including processor 630 which may act as a co-processor or hardware accelerator unit for a host processing unit 610. It will be appreciated that the types of hardware accelerator which the processor 630 may provide dedicated circuitry for is not limited to that of Neural Processing Units (NPUs) or Graphics Processing units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g. supporting large numbers of execution threads), and are optimized for data-plane (rather than control plane) processing, all of which means that GPUS may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable, to utilize some of the GPU's existing resources (e.g. such that at least some functional units and resource of the GPU can effectively be shared between the different hardware accelerator circuitry, for instance), whilst still allowing an improved (more optimized) performance compared to performing all the processing with general purpose execution.

As such, the processor 630 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor, this means that the machine learning processing circuit is preferably then operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 1b, the processor 630 is arranged to receive a command stream 620 from a host processor 610, such as a central processing unit (CPU). The command stream 620 comprises at least one command in a given sequence, each command to be executed, and each command may be decomposed into a number of tasks, such as tasks discussed in this document. These tasks may be self-contained operations, such as a given machine learning operation or a graphics processing operation. It will be appreciated that there may be other types of tasks depending on the command.

The command stream 620 is sent by the host processor 610 and is received by a command processing unit 640 which is arranged to schedule the commands within the command stream 620 in accordance with their sequence. The command processing unit 640 is arranged to schedule the commands and decompose each command in the command stream 620 into at least one task. Once the command processing unit 640 has scheduled the commands in the command stream 620, and generated a plurality of tasks for the commands, the command processing unit 640 issues each of the plurality of tasks to at least one compute unit 650a, 650b each of which are configured to process at least one of the plurality of tasks.

The processor 630 comprises a plurality of compute units 650a, 650b. Each compute unit 650a, 650b, may be a shader core of a GPU specifically configured to undertake a number of different types of operations, however it will be appreciated that other types of specifically configured processor may be used, such as a general-purpose processor configured with individual compute units, such as compute units 650a, 650b. Each compute unit 650a, 650b comprises a number of components, and at least a first processing module 652a, 652b for executing tasks of a first task type, and a second processing module 654a, 654b for executing tasks of a second task type, different from the first task type. In some examples, the first processing module 652a, 652b may be a processing module for processing neural processing operations, such as those which would normally be undertaken by a separate NPU. In these cases, the first processing module 652a, 652b is for example a neural engine. Similarly, the second processing module 654a, 654b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader tasks, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 640 issues tasks of a first task type to the first processing module 652a, 652b of a given compute unit 650a, 650b, and tasks of a second task type to the second processing module 654a, 354b of a given compute unit 650a, 650b. The command processing unit 640 would issue machine learning/neural processing tasks to the first processing module 652a, 652b of a given compute unit 650a, 650b where the first processing module 652a, 652b is optimized to process neural network processing tasks, for example by comprising an efficient means of handling a large number of multiply-accumulate operations. Similarly, the command processing unit 640 would issue graphics processing tasks to the second processing module 654a, 654b of a given compute unit 650a, 650b where the second processing module 652a, 654a is optimized to process such graphics processing tasks. In some examples, the first and second may both be neural processing tasks issued to a first processing module 652a, 652b, which is a neural engine. Such a neural processing task may involve the processing of a tensor, e.g. representing a feature map, with weights associated with a layer of a neural network.

In addition to comprising a first processing module 652a, 652b and a second processing module 654a, 654b, each compute unit 650a, 650b also comprises a memory in the form of a local cache 656a, 656b for use by the respective processing module 652a, 652b, 654a, 654b during the processing of tasks. Examples of such a local cache 656a, 656b is a L1 cache. The local cache 656a, 656b may, for example, a synchronous dynamic random-access memory (SDRAM). For example, the local cache 656a, 656b may comprise a double data rate synchronous dynamic random-access memory (DDR-SDRAM). It will be appreciated that the local cache 656a, 656b may comprise other types of memory.

The local cache 656a, 656b is used for storing data relating to the tasks which are being processed on a given compute unit 650a, 650b by the first processing module 652a, 652b and second processing module 654a, 654b. It may also be accessed by other processing modules (not shown) forming part of the compute unit 650a, 650b the local cache 656a, 656b is associated with. However, in some examples, it may be necessary to provide access data associated with a given task executing on a processing module of a given compute unit 650a, 650b to a task being executed on a processing module of another compute unit (not shown) of the processor 630. In such examples, the processor 630 may also comprise storage 660, for example a cache, such as an L2 cache, for providing access to data use for the processing of tasks being executed on different compute units 650a, 650b.

By providing a local cache 656a, 656b tasks which have been issued to the same compute unit 650a, 650b may access data stored in the local cache 656a, 656b, regardless of whether they form part of the same command in the command stream 620. The command processing unit 640 is responsible for allocating tasks of commands to given compute units 650a, 650b such that they can most efficiently use the available resources, such as the local cache 656a, 656b, thus reducing the number of read/write transactions required to memory external to the compute units 650a, 650b, such as the storage 660 (L2 cache) or higher level memories. One such example, is that a task of one command issued to a first processing module 652a of a given compute unit 650a, may store its output in the local cache 656a such that it is accessible by a second task of a different (or the same) command issued to a given processing module 652a, 654a of the same compute unit 650a.

One or more of the command processing unit 640, the compute units 650a, 650b, and the storage 660 may be interconnected using a bus. This allows data to be transferred between the various components. The bus may be or include any suitable interface or bus. For example, an ARM® Advanced Microcontroller Bus Architecture (AMBAR) interface, such as the Advanced extensible Interface (AXI), may be used.

FIG. 2 is a schematic diagram of a neural engine 700, which in this example is used as a first processing module 652a, 652b in a data processing system 600 in accordance with FIG. 1b. The neural engine 700 includes a command and control module 710. The command and control module 710 receives tasks from the command processing unit 640 (shown in FIG. 1b), and also acts as an interface to storage external to the neural engine 700 (such as a local cache 656a, 656b and/or a L2 cache 660) which is arranged to store data to be processed by the neural engine 700 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the neural engine 700 to perform particular processing and/or data to be used by the neural engine 700 to implement the processing such as neural network weights.

The command and control module 710 interfaces to a handling unit 720, which is for example a traversal synchronization unit (TSU). In this example, each task corresponds to a stripe of a tensor which is to be operated upon in accordance with a sequence of operations according to at least a portion (e.g. a sub-graph) of the acyclic graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In this example, the operations are structured as a chain of operations representing a sequence of layers of the neural network. A block of data is allocated as an input to one of the operations by the handling unit 720.

The handling unit 720 coordinates the interaction of internal components of the neural engine 700, which include a weight fetch unit 722, an input reader 724, an output writer 726, a direct memory access (DMA) unit 728, a dot product unit (DPU) array 730, a vector engine 732, a transform unit 734, an accumulator buffer 736, and a storage 738, for processing of blocks of data. The data dependencies across the functional units are tracked by the handling unit 720. Processing is initiated by the handling unit 720 in a functional unit if all input blocks are available and space is available in the storage 738 of the neural engine 700. The storage 738 may be considered to be a shared buffer, in that various functional units of the neural engine 700 share access to the storage 738.

In the context of a directed acyclic graph representing the operations to be performed, each of the internal components that operates upon data can be considered to be one of two types of component. The first type of component is an execution unit (and is identified within the neural engine 700 as such) that maps to a section that performs a specific instance of an operation within the acyclic graph. For example, the weight fetch unit 722, input reader 724, output writer 726, dot product unit array 730, vector engine 732, transform unit 734 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The connections between sections in the acyclic graph representing the neural network are also referred to as pipes within the context of the acyclic graph. These pipes can also be mapped to the uniquely identified physical storage elements in the neural engine. For example, the accumulator buffer 736 and storage 738 (and portions thereof) can each be regarded as a storage element that can act to store data for a pipe within the acyclic graph. The pipes act as connections between the sections (as executed by execution units) to enable a sequence of operations as defined in the acyclic graph to be chained together within the neural engine 700. Put another way, the logical dataflow of the acyclic graph can be mapped to the physical arrangement of execution units and storage elements within the neural engine 700. Under the control of the handling unit 720, execution can be scheduled on the execution units and data can be passed between the execution units via the storage elements in accordance with the mapping, such that the chained operations of a graph can be executed without needing to write data memory external to the neural engine 700 between executions.

The handling unit 720 is configured to control and dispatch work representing performing an operation of the graph on at least a portion of the data provided by a pipe.

The weight fetch unit 722 fetches weights associated with the neural network from external storage and stores the weights in the storage 738. The input reader 724 reads data to be processed by the neural engine 700 from external storage, such as a block of data representing part of a tensor. The output writer 726 writes data obtained after processing by the neural engine 700 to external storage. The weight fetch unit 722, input reader 724 and output writer 726 interface with the external storage (which is for example the local cache 656a, 656b, which may be a L1 cache such as a load/store cache) via the DMA unit 728.

Data is processed by the DPU array 730, vector engine 732 and transform unit 734 to generate output data corresponding to an operation in the acyclic graph. The result of each operation is stored in a specific pipe within the neural engine 700. The DPU array 730 is arranged to perform one or more operations associated with a dot product operation between two operands, such as between an array of weights and a corresponding block of data (e.g. representing part of a tensor). The vector engine 732 is arranged to perform elementwise operations, for example to apply scale parameters to scale an output of a dot product calculated by the DPU array 730. Data generated during the course of the processing performed by the DPU array 730 and the vector engine 732 may be transmitted for temporary stage in the accumulator buffer 736 which acts as a pipe between the previous operation and the subsequent operation, from where it may be retrieved by either the DPU array 730 or the vector engine 732 (or another different execution unit) for further processing as desired.

The transform unit 734 is arranged to perform in-block transforms such as dimension broadcasts or axis swaps. The transform unit 734 obtains data from a pipe, such as storage 738 (e.g. after processing by the DPU array 730 and/or vector engine 732), and writes transformed data back to the storage 738.

To make efficient use of the storage 738 available within the neural engine 700, the handling unit 720 determines an available portion of the storage 738, which is available during execution of part of a first task (e.g. during processing of a block of data associated with the first task by the DPU array 730, vector engine 732 and/or transform unit 734). The handling unit 720 determines a mapping between at least one logical address associated with data generated during execution of a second task (e.g. by processing of a block of data associated with the second task by the DPU array 730, vector engine 732 and/or transform unit 734) and at least one physical address of the storage 738 corresponding to the available portion. The logical address is for example a global address in a global coordinate system. Hence, by altering the physical address corresponding to a given logical address, the handling unit 720 can effectively control usage of the storage 738 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes.

All storage in the neural engine 700 may be mapped to corresponding pipes, including look-up tables, accumulators, etc. Some storage may be relatively fixed purpose, for example, if the hardware were limited to one convolution operation per graph the accumulator buffer might also be limited to being mapped to one pipe, and scale/bias/shift buffer might be limited to being mapped to one pipe; however both would likely be double buffered. If the neural engine supports 2 look-up tables (LUTs), then a maximum of 2 pipes could be used to target the LUTs to avoid needing to thrash the LUT storage; LUT pipes might then be single buffered. All other pipes could be mapped to a common Shared Buffer (or portions thereof) with fewer restrictions. Width and height of pipe can also be programmable, resulting a highly configurable mapping between pipes and storage elements within the neural engine 700.

Ordering of execution of the sections is implied by dependencies on inputs. A memory load operation has no data dependencies (unless it is a gather operation), so is implicitly early in the graph. The consumer of the pipe the memory read produces is implicitly after the memory read. A memory store operation is near the end of the graph, as it produces no pipes for other operations to consume. The sequence of execution of a chain of operations is therefore handled by the handling unit 720 as will be explained in more detail later.

FIG. 3 shows schematically a system 800 for allocating handling data, and in some examples generating a plurality of blocks of input data for processing.

The system 800 comprises host processor 810 such as a central processing unit, or any other type of general processing unit. The host processor 810 issues a command stream comprising a plurality of commands, each having a plurality of tasks associated therewith.

The system 800 also comprises a processor 830, which may be similar to or the same as the processor 630 of FIG. 1b, and may comprise at least some of the components of and/or be configured to perform the methods described above. The processor 830 comprises at least a plurality of compute units 650a, 650b and a command processing unit 640. Each compute unit may comprise a plurality of processing modules each configured to perform at least one type of operation. The system 800 may also include at least one further processor (not shown), which may be the same as the processor 830. The processor 830, and the host processor 810 may be combined as a System on Chip (SoC) or onto multiple SoCs to form one or more application processors.

The system 800 also comprises memory 820 for storing data generated by the tasks externally from the processor 830, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 650a, 650b of a processor 830 so as to maximize the usage of the local cache 656a, 656b.

In some examples, the system 800 may comprise a memory controller (not shown), which may be a dynamic memory controller (DMC). The memory controller is coupled to the memory 820. The memory controller is configured to manage the flow of data going to and from the memory. The memory may comprise a main memory, otherwise referred to as a ‘primary memory’. The memory may be an external memory, in that the memory is external to the system 800. For example, the memory 820 may comprise ‘off-chip’ memory. The memory may have a greater storage capacity than local caches of the processor 830 and/or the host processor 810. In some examples, the memory 820 is comprised in the system 800. For example, the memory 820 may comprise ‘on-chip’ memory. The memory 820 may, for example, comprise a magnetic or optical disk and disk drive or a solid-state drive (SSD). In some examples, the memory 820 comprises a synchronous dynamic random-access memory (SDRAM). For example, the memory 820 may comprise a double data rate synchronous dynamic random-access memory (DDR-SDRAM).

One or more of the host processor 810, the processor 830, and the memory 820 may be interconnected using a system bus 840. This allows data to be transferred between the various components. The system bus 840 may be or include any suitable interface or bus. For example, an ARM® Advanced Microcontroller Bus Architecture (AMBA®) interface, such as the Advanced extensible Interface (AXI), may be used.

The neural engine 700 receives tasks from the command processing unit 640 to execute operations from the acyclic graph. The neural engine 700 is configured to execute operations selected from a base set of operations defining an operator set. One example of such an operator set is the Tensor Operator Set Architecture (TOSA) base inference profile, which defines a set of operations that can collectively be used to define the operations of a wide range of neural network operations. One exception to the TOSA operator set is control flow operations that may be implemented by way of a command stream processed by the command processing unit 640. It will be appreciated that there may be multiple neural engines with the processor 630 and thus multiple tasks can be issued concurrently to different neural engines.

In an example implementation, a task issued by the command processing unit 640 for execution by the neural engine 700 may be considered a RUN_NEURAL instruction. This instruction initiates running of a neural graph bounded in a 4D space. Neural graphs are executed on the neural engine and the neural graph is described by task data which in this example is embodied by a neural engine program descriptor (NED), which is a data structure stored in memory and retrieved by the neural engine when executing the task issues by the command processing unit.

A neural engine task describes a 4D bounding box (dimensions #0-3) that should be operated on by the section operations of a graph defined by a NED that the task provides a pointer to. As well as describing the graph, the NED also defines a further four dimensions (dimensions #4-7), making for a total 8-dimension operation-space. The bounding box for the first four dimensions is a sub-region of the full size of these dimensions, with different tasks and/or jobs covering other sub-regions of these dimensions.

Moreover, it is necessary for any dependencies that need to be met for the execution unit to operate on the block. These include that the required data is stored in the source pipe(s) for the operation and that sufficient storage is available in the destination pipe, as well as that the transform of the operation space to section space for that section has been performed and the output of that transform operation (i.e. the transformed coordinate data) is available to be issued to the execution unit. More specifically, it is to be ensured that there is sufficient availability in the pipe for a new block or buffer.

Embodiments will now be described where the present invention allows for early fetching of neural network processing data structures and for overlap of job execution within a neural engine 700 even if dependencies have not been resolved.

Embodiments will now be described where the present invention allows for getting tasks sent to the Neural Engine 700 from the command processing unit 640 earlier even if dependencies have not been resolved.

The iteration process first involves reading from the NED a block size and iterating through the operation space one block at a time. For each block, a transform program is executed to transform the operation space coordinates to section space coordinates for that section. More detail on the transform programs is set out below. Once the section space coordinates have been determined, the section operation is performed in respect of that block. This process is iterated over all blocks until the operation is completed for all blocks.

Whilst embodiments described in this application can support more dimensions, in the present example a RUN_NEURAL command describes a job to be executed in 8D operation-space and a bounding box for four outer dimensions is specified through a starting offset and size:
job_offset_dim0-job_size_dim0
job_offset_dim1-job_size_dim1
job_offset_dim2->job_size_dim2
job_offset_dim3-job_size_dim3

The inner four dimensions are executed in their entirety within the job, and as such always start at 0 and have their total size specified in the NED.

Neural jobs represent a sub-stripe, typically one half of a stripe. A stripe is a unit of a compiler-planned neural cascade, in which the size of stripes is designed around the expected maximum usage of the GPU's L2 cache. The intention is that all the inputs and output should fit in the cache, allowing successive stripes to be grouped together in a cascade with maximum reuse of data and minimum external memory re-read. A neural cascade can also include stripes executing as compute jobs. A pair of sub-stripes are executed consecutively and serve the purpose of removing data-dependencies between successive jobs in the cascade.

The neural job uses an iterator to split the four outer dimensions into smaller bounding boxes for tasks to execute on individual Neural Engines. A job can be divided into a maximum of 256 tasks although a will be appreciated by a person skilled in the art, a maximum number of tasks can be specific to the job. Larger tasks are usually more efficient as this allows for more reuse of data within the Neural Engine, but this is constrained by the limit on stripe size defined by the L2 cache size. Typically, the iterator is configured to create one task per available Neural Engine. This may not match up if the number of engines changes between compile time and run time. Additionally, if the job size is particularly small, it may not make sense to split the job up to provide for each engine.

Embodiments may comprise more or less dimensions and in the present embodiment, the iterator is configured to iterate through any two dimensions as an outer loop and an inner loop, each with an independent increment size:
iterator_outer_dimension→task_increment_outer
iterator_inner_dimension→task_increment_inner

The iterator splits the specified dimensions according to their corresponding increment size, with iteration performed like a nested loop with the inner task split as a loop inside the outer task split. When the inner task split completes its iteration, it wraps round to the beginning and the outer task split increments one step. The inner task split is then repeated again, with the whole processes repeated until the output task split completes its iteration. If the upper boundary of a task extends beyond the job bounding box in one of these iteration dimensions, then this dimension saturates at the upper limit of the job bounding box. If the lower boundary extends beyond the bounding box for the inner task split, then the outer task split is incremented and the inner task split loop is restarted. If the lower boundary extends beyond the bounding box for the outer task split, then iteration has been completed.

Outstanding asynchronous commands from the command stream are tracked through the use of scoreboards. To resolve dependencies between different commands, typically a blocking WAIT instruction is used to wait on one or more scoreboard entries.

In embodiments, processing may be implemented to support 16 scoreboards, although a person skilled in the art will appreciated that other numbers of scoreboards are available. For example, according to present techniques, we have a configuration that says: every time we dispatch a RUN_NEURAL, increment scoreboard X. And then when the RUN_NEURAL completes, decrement scoreboard X.

In an alternative technique we may have a configuration that says: every time we dispatch a task from a RUN_NEURAL, increment scoreboard X. Every time a core/NE indicates it has finished a RUN_NEURAL task, decrement scoreboard X.

So tracking a job as a whole (which requires a hidden task tracking), or tracking individual tasks directly can achieve the same outcome and in a preferred embodiment tasks may be tracked directly.

For each RUN_NEURAL we can change which scoreboard we are using. Likewise RUN_COMPUTE/etc. Present techniques allow for a mix of NEURAL/COMPUTE outstanding on the same and different scoreboards.

Then the WAIT instruction has a 16b mask, one bit for each of the 16 scoreboards. The WAIT instruction blocks until every scoreboard selected has been decremented to 0, indicating all the relevant outstanding jobs/tasks are 0.

The RUN_NEURAL command can optionally be dispatched without resolving all of its dependencies. This mode is enabled by specifying the scoreboard dependencies in the RUN_NEURAL command through the wait_mode and sb_mask fields, in much the same way as the equivalent WAIT instruction would be specified, but without needing the blocking WAIT.

Using a sb_mask (or sb_mask_wait in indirect mode) that includes the active scoreboard entry for asynchronous endpoint tasks means that the iterator works as normal to send tasks to the Neural Engines, but must indicate that there are outstanding dependencies, and later follows this with a separate indication once these dependencies are resolved.

As described above, a wait_mode specifies whether or not the processing is in immediate mode (sb_mask) or indirect mode (sb_mask_wait). wait_mode is a field in the WAIT instruction and the enhanced RUN_NEURAL instruction. sb_mask is encoded directly in the WAIT instruction, and the enhanced RUN_NEURAL instruction. So sb_mask is a field just like wait_mode.

sb_mask_wait is separate state stored by the command stream front end. Its value is modified by a separate SET_STATE instruction.

Of note, is that sb_mask is part of the instruction encoding, and so therefore somewhat static. Whereas sb_mask_wait can be set programmatically, and therefore more dynamic.

This mechanism allows various non-dependent work to be started in the Neural Engine before the dependencies have been resolved. This is particularly advantageous when the aforementioned stripes are too small to warrant splitting into sub-stripes, meaning that successive RUN_NEURAL commands may have back-to-back dependencies.

Before the dependencies have been resolved, the Neural Engine is able to fetch the NED as well as descriptors. It is also legal to fetch any constant resources or resources for which it is known that dependencies have been resolved.

Instructions contained a part of a control handshake between the command stream front end and the Neural Engine determine what actions the Neural Engine is allowed to perform, such as fetching descriptors and resources, before being sent a message to start executing the task. The Neural Engine can be instructed to go and fetch descriptors and resources that are required ahead of executing a task, whilst being instructed to hold off executing, for example a task A until the command stream front end has received a completion message from prior tasks that resolve all prior data dependencies that task A has on other tasks.

The NEDWeightFetchElement only accesses constant weight streams.

The NEDInputReaderElement accesses tensors, and can indicate that they are constant or that it is known that any dependencies will have been resolved in advance, through a dependency_nowait field.

The dependency system built into the NE for handling the graph described by the NED means that all aspects of the graph that consume these resources are safe to execute according to the normal execution and dependency rules of the NE, as described above with reference to command and control module 710 and handling unit 720. The only exception to this is storing data out as described by the NEDOutputWriterElement; no such operations are permitted to run until the RUN_NEURAL dependencies have been resolved.

Storing data out through the NEDOutputWriterElement may cause dependency issues, particularly if it targets a rolling buffer: if writing to a rolling buffer and the previous command is reading from that same rolling buffer then it is not possible to write safely to the buffer. For example, if the write is the second stripe of a first layer, while the previous command including a read is the first stripe of a second layer. This could be resolved in some cases by adding a similar dependency_nowait field to the NEDOutputWriterElement. However, in the majority of cases the store is at the end of a graph: if all other execution has successfully completed, it is likely that the dependencies have already been resolved; if a dependency hasn't been resolved, it would be a rare graph with multiple outputs with the dependent inputs not factoring into this specific output.

An immediate wait_mode can be used with a zero sb_mask if all dependencies are resolved in advance or if there are no dependencies using the blocking WAIT instruction.

The NED describes at least a portion of a complete graph of operations (sections) to be performed when executing the graph of operations (e.g. representing a neural network). As discussed above, sections are mapped to various hardware execution units within the neural engine 700 and essentially represent instantiations of a particular operator at a position within the graph. In one example, these sections are described by specific ‘elements’ that collectively define the operations forming part of the NED. Furthermore, the NED has an unordered list of pipes (graph vertices) and an unordered list of sections/operations (graph nodes). Each operation specifies its input and output pipes giving rise to adjacency of operation in the acyclic graph to which a particular operation is connected.

An example NED comprises a NED structure comprising a header, the elements each corresponding to a section in the graph. The NED describes the various requirements of ordering, number and relationship of these sections and pipes.

In one implementation, each of the execution units and each storage element (or portion of a storage element) of the neural engine 700 has a sub-descriptor definition which defines how that execution unit/storage element can be configured for use in implementing a specific section or pipe in the graph. An example of the hardware units and their corresponding elements is set out below:
Weight Fetch (WF): NEDWeightFetchElement
Input Reader (IR): NEDInputReaderElement
Output Writer (OW): NEDOutputWriterElement
Convolution Engine (CE): NEDConvolutionEngineElement
Transform Unit (TU): NEDTransformUnitElement
Vector Engine (VE): NEDVectorEngineElement

The NED therefore may specify the execution unit or in other words specify a compatible execution unit for each operation. In embodiments there may be more than one execution unit of a given type such as InputReader may have two command queues which can operate concurrently. The InputReader element (IR) describes the configuration of an InputReader section in the NED graph. The InputReader is responsible for loading data from external memory into pipes and is therefore an execution unit operable to perform a memory load access to initiate a execution of a sub-graph.

In operation, an input reader reads data as part of a section of a graph and so dependencies need to be tracked at the input reader, because any memory load access that is expressed at a start of a graph is possibly dependent on the outcome of another graph.

Accordingly, when the NED specifies to the input reader instructions to carry out a memory load access, the NED also includes an indication that all outstanding dependencies from the instructions set command have been resolved or an indication that all outstanding dependencies from the instruction set command must be resolved before a section is invoked with any blocks.

A NED may specify which of the queues is assigned so that there remains a 1:1 relationship between what the NED specifies and the physical hardware to which it points.

In general, one or more of the InputReaders in the NED has a dependency on the previous job. If it did not have a dependency then the job would have been submitted without any dependencies. However, in many common NEDs, there are other InputReaders that represent compile-time constant data (such as LUTs or Scale/Bias/Shift parameters) as well as InputReaders that represent dynamic data, but calculated in the job not immediately preceding and thus not an immediate dependency. The WeightFetch similarly represents compile-time constant data.

It is safe for the TSU to issue blocks of these to the DMA and begin fetching their data. To enable this, a single-bit field dependency_nowait to indicate whether a dependency exists or not is added to the InputReader element, while the WeightFetch is always presumed to be non-dependent.

The NED Input reader element dependency_nowait is stored in bit of word 0 and is a 1-bit Boolean flag. The field can contain the following values:

Value 0. Description: All outstanding dependencies from the RUN_NEURAL command must be resolved before this section is invoked with any blocks.

Value 1: Description: Any outstanding dependencies from the RUN_NEURAL command can be ignored for this section.

Once blocks of data have been fetched into their pipes, it is entirely reasonable for further consuming operations to be executed, whether on the ConvolutionEngine, TransformUnit or VectorEngine. This represents normal behaviour for the section and pipe control and dependency scheme and is subject to the normal rules of task overlap according to conventional systems prior to the present technology

In summary, in embodiments an indication flag in the form of a single bit is added for each InputReader to indicate whether it can execute without the dependencies being resolved. All other section types can be processed irrespective of the dependencies, except typically in the majority of scenarios for the OutputWriters which can only ever execute once the dependencies are resolved.

In one embodiment, deferred dependency tracking may be made against the command stream's scoreboards. The RUN_NEURAL instruction is extended with a 16b multi-hot bitmask indicating the scoreboards on which we have dependencies; this can either be in the instruction encoding or as an input staging register. Local scoreboards may be used although such techniques may be implemented with shared scoreboards.

In a variation, the scoreboard bitmask is set separately using a SET_STATE instruction. This allows the bitmask to be set from a register rather than fixed in the RUN_NEURAL encoding. This mirrors the WAIT instruction's two wait modes: immediate and indirect.

On receiving this instruction, the iterator behaves as normal: there is no synchronization at this stage. There is no synchronization at this stage because these RUN_* commands or instructions are typically considered asynchronous/non-blocking as relative to the command stream front end and the commands or instructions that it runs.

Tasks are signalled to the NEs as normal but indicating that they have a deferred dependency. The NE is allowed to do relevant non-dependent work: At a basic level, this may comprise fetching descriptors, but the extension to the task overlap scheme described above allows for real work to be performed (where marked as non-dependent).

Once all the scoreboards marked in the bitmask have decremented to 0, the NE is permitted to execute the dependent work of the task.

If the job is specified with the bitmask set to 0, then there are no scoreboard dependencies, and the behaviour matches the behaviour of conventional systems prior to the present technology, making this implementation backwards compatible.

This solution can be performant enough that it can always be used: it can replace every existing RUN_NEURAL and most existing explicit command stream scoreboard synchronizations. The benefit of specifying dependencies by scoreboard makes this a relatively easy drop-in change for command streams developed prior to the present technology, making the software cost low for users.

In one possible implementation, the scoreboard bitmask may be signalled to the NE as part of the initial context setup

Every time a relevant scoreboard decrements to 0, the iterator can signal to all the relevant NEs that this scoreboard is now 0.

This makes the NE responsible for tracking which scoreboards it is waiting for. There is not a specific message that indicates that all the dependencies are resolved.

The neural iterator can maintain a single bitmask for all its outstanding jobs, OR′ing in the bitmask specified in each new job. When a scoreboard matching this single bitmask reaches 0, then a JCN message can be signalled. The iterator can similarly maintain a single bitmask of which NEs it has outstanding tasks at. This allows for simplifies tracking, but results in NEs potentially receiving scoreboard clear messages for scoreboards they were not waiting for.

Preferably the initial bitmask signalled to the NE in the initial context setup would be cleared of any scoreboards already at 0. This would mean that where dependencies are already resolved, no follow-up messages are required.

Alternatively, most of the tracking may be handled by the iterator. In this case, when the task is signalled to the NE, the NE only needs to know whether any dependencies are outstanding. The iterator can then inform the NE with a single message once all dependencies for that job are resolved. The same care must be taken to handle the case where all the dependent scoreboards are already at 0.

In a further alternative implementation, dependencies may instead be specified more coarsely based on the type of job which is dependent. This is less performant than the scoreboard proposal above, but it is an alternative as it provides an alternative implementation.

In this alternative implementation, a new field in RUN_NEURAL provides the following options:
no wait (conventional behaviour)
wait for compute
wait for neural.
wait for compute and neural

On receiving this instruction, the iterator behaves as normal: there is no synchronization at this stage.

Tasks are signalled to the NEs as normal but indicating that they have a deferred dependency. The NE is allowed to do relevant non-dependent work: currently this just means fetching descriptors, but the extension to the task overlap scheme described separately allows for real work to be performed (where marked as non-dependent).

Once all preceding jobs of the specified type have completed, the NE is permitted to execute the dependent work of the task.

If the job is specified with the “no wait” option, then there are no scoreboard dependencies, and the behaviour matches the conventional behaviour, making this variant implementation backwards compatible.

It is an implementation choice whether the iterators send multiple JCN messages of completion (one for compute, one for neural) and it is up to the NE to keep track of what it is waiting for, or if the iterators keep track of what is required and send a single specific message to indicate all dependencies are resolved.

As a further alternative implementation, a mechanism to identify dependencies based on the resources being accessed may be provided. The RUN_NEURAL command allows a NE program to access resources across four resource tables. A scheme might be created to identify that dependencies exist for some resource tables and not others. For example, a resource table might be linked to a specific scoreboard entry.

The NE program contains multiple memory access operations (such as the InputReader). These operations indicate that they will access a specific resource table (nrt_num) and a specific descriptor from that table (nrt_index). The NE program is parsed in its entirety upfront, before executing it across the provided bounding box. Therefore, the NE knows exactly which of the resource tables it will access, by looking at the nrt_num of all the memory access operations. If it knows which tables it will access, it can know to wait for an indication that there are no dependencies on these resource tables. In other words, this is the equivalent of the NE determining for itself which scoreboards it is dependent on.

In various implementations, the command stream front end may have knowledge of which resource tables an NE program is writing to, thus the equivalent of which scoreboards are active and should block. This could be achieved by the NE responding to a task after parsing the parsing and indicating which resource tables its store operations (OutputWriter) use.

Alternatively, the RUN_NEURAL may indicate which resource tables the NE program will use. This can cover both sides: which resource tables the program will read from and which resource tables the program will write to. However, this breaks the separation of the RUN_NEURAL command from the NE program it dispatches is applicable to certain GPU architectures.

In an example implementation, the neural engine is stateless between tasks: all control state is encapsulated in the task's NED, and all data is encapsulated in the pipes defined by the NED. There is no sharing of pipes between tasks and therefore no architected sharing of data between tasks within the neural engine 700. Data reuse and sharing is achieved only through memory by use of the Output Writer in a preceding task and the Input Reader in a later task. The neural engine will cache memory descriptors, including the NED, between tasks; this cache is invalidated each time a complete neural workload is completed (e.g. the total neural network and not just the sub-graph associated with a specific task). However, it will be appreciated that this is just an example implementation.

The NED therefore essentially identifies the operation space and a count of all instances of sections and pipes (for each type of hardware element that is to be allocated for instantiating a section or a pipe that will be required to execute the graph (or sub-graph)) defined by the NED. An illustrative example of at least a portion of the fields stored in the NED header is set out below. In addition to the NED header, the NED further comprises sub-descriptor elements (defining either the configuration of an execution unit or storage element to operate as a section or pipe) for each instance of a section and/or pipe. Each sub-descriptor element defines the configuration of the associated hardware element (either execution unit or storage element) required to execute the section and/or pipe.

An example of at least some of the fields in a NED header is set out below:

| Field | Min | Max |
|---|---|---|
| Operation space size for dimension 1 | — | — |
| Operation space size for dimension 2 | — | — |
| Operation space size for dimension 3 | — | — |
| Operation space size for dimension 4 | — | — |
| Operation space size for dimension 5 | — | — |
| Operation space size for dimension 6 | — | — |
| Operation space size for dimension 7 | — | — |
| Number of weight fetch and decode | 0 | 1 |
| sections | | |
| Number of input reader sections | 1 | 7 |
| Number of output write sections | 1 | 7 |
| Number of convolution engine sections | 0 | 1 |
| Number of transform unit sections | 0 | 7 |
| Number of vector engine sections | 0 | 7 |
| Number of pipes | 1 | 15 |

theoretical minimum and maximum operation space dimension sizes may be defined at compilation based on the configuration of the neural engine, specifically such that the operations of the task (e.g. sub-graph) can be performed without requiring intermediate data to be stored in a memory element outside of the neural engine. A practical approach to defining a task and its corresponding operation space is set out in more detail later.

The NED may also comprise pointers to each of the sub-descriptor elements to enable the specific configuration of each element to be read by the handling unit 720.

As mentioned, each instance of the sub-descriptor element defines a configuration of the hardware element (e.g. execution unit or storage element) to which it relates. The following description will provide an example sub-descriptor for a convolution engine.

In an example, the convolution engine is an execution unit which is configured, when invoked, to perform a convolution or pooling operation selected from one or more convolution operations for which the convolution engine is configured. One such example is a 2D convolution operation as described above. In the example of the 2D convolution operation described above, the operation space is 7D-namely [oc, n, oy, ox, ic, ky, kx].

Field
Stride X and Stride Y
Dilation X and Dilation Y
Operation type (e.g. which type of
convolution operation is to be
performed)
Input width and height
Pad Left
Pad Top
Source 0 pipe (input feature map pipe)
Source 1 pipe (weight pipe)
Destination pipe

In this example, the operation type may for example take the form of one of pooling (average or max pooling), 2D convolution, or 2D depth-wise convolution. The source 0 pipe field might identify from which pipe the convolution engine should read the input feature map data—this may for example be a specific portion of a shared buffer. Similarly the source 1 pipe field might indicate from which (different) portion of the shared buffer the weight data is to be retrieved. Finally, the destination pipe might indicate that an accumulation buffer is to act as the pipe for the output of the operation performed by the convolution engine. By identifying for a section specific source and/or destination pipes, which have unique identifiers in the task definition (the NED), any preceding or subsequent sections are implicitly connected and sequenced. Another sub-descriptor element referencing the destination pipe of a different section as a source pipe will inherently read that data and the buffer allocation for that destination pipe may only be released once all of the dependencies have been resolved (e.g. that the sections that rely on that portion of the accumulation buffer have all completed reading that data).

Similar sub-descriptor elements exist for all sections based on configuring the execution units to perform operations. For example, sub-descriptor elements may define destination and source pipes, a pointer to a transform from operation to section space, and a mode of operation for the section.

The output of the neural network processing may be written to memory, or may be provided directly to a processor for use as an input, for example.

The data processing system may comprise and/or be in communication with one or more memories (such as the memories described above) that store the data described herein, and/or store software for performing the processes described herein. The data processing system may comprise and/or be in communication with a host microprocessor, and/or with a display for displaying output data associated with the neural network processing.

The data processing system of the present invention may be implemented as part of any suitable system, such as a suitably configured micro-processor based system. In some embodiments, the present invention is implemented in a computer and/or micro-processor based system.

The various functions of the present invention may be carried out in any desired and suitable manner. For example, the functions of the present invention may be implemented in hardware or software, as desired. Thus, for example, the various functional elements, units, etc., of the present invention may comprise a suitable processor or processors, controller or controllers, functional units, circuits, processing logic, microprocessor arrangements, etc., that are operable to perform the various functions, etc., such as appropriately dedicated hardware elements (processing circuits) and/or programmable hardware elements (processing circuits) that can be programmed to operate in the desired manner.

FIG. 4 shows in much simplified form a method 400 of operation according to the present disclosure, the method being suitable for use in an execution unit of a processor that is configured to perform neural network processing. The method commences at START INSTANCE 402, and at 404, a task and a set of indications are received by the execution unit. At 406, the indications are analyzed and at 408 at is determined, for example, that the task can start at least some processing at the execution unit in spite of unresolved dependencies because the requisite flag or other indicator is set in the set of indications. In one implementation, at 410 it is determined which work items of the task can be processed at the execution unit in spite of unresolved dependencies, and at 412, the relevant operations are performed. At 414 it is detected that one or more unresolved dependencies have become resolved, and as a consequence processing of the task can complete 416 at the execution unit. This instance of the method 400 completes at END INSTANCE 418. As will be clear to one of skill in the art, the method 400 as shown here comprises a single instance, and further instances may concurrently and/or subsequently be performed starting at 402.

It should also be noted here that, as will be appreciated by those skilled in the art, the various functions, etc., of the present invention may be duplicated and/or carried out in parallel on a given processor. Equally, the various processing circuits may share processing circuits, etc., if desired.

It will also be appreciated by those skilled in the art that all of the described embodiments of the present invention may include, as appropriate, any one or more or all of the features described herein.

Embodiments such as described above include, but are not limited to the data processing system including the indication flag comprised in a set of indications sent by the control circuit to multiple execution units, wherein the execution units are input readers and each input reader receives the indication flag in its set of indications. An input reader is permitted to fetch second data where no overlap with first data associated with a said unresolved dependency is detected. The execution unit caused to operate with a said unresolved dependency is provided with a signal after execution begins to indicate that the dependency has been resolved. When data is fetched from storage to be processed by the neural network, the data is operable upon in accordance with a sequence of operations according to at least a portion of a graph, such as an acyclic graph, representation of the neural network. The execution unit caused to operate with a said unresolved dependency is further caused to wait when the graph reaches an output stage until said unresolved dependency is resolved. The portion is represented by a sub-graph of the graph representation of the neural network. Connections between sections in the graph representing the neural network are pipes and are mapped to storage elements in the processor. The control unit is configured to control and dispatch work representing an operation of the graph on at least a portion of the data provided by a pipe when the required data for the operation is stored in the pipe. An execution unit is operable to perform a memory load access to initiate a sequence of operations according to at least a portion of a graph representation of the neural network.

According to a method of operating an execution unit of a processor it will also be appreciated by those skilled in the art that all of the described embodiments of the present invention may include, as appropriate, any one or more or all of the features described herein.

Embodiments such as described above include further comprising receiving the set of indications including the indication flag at an input reader, wherein optionally receiving a set of indications comprises receiving at least a single bit indication. Permitting an input reader to fetch second data where no overlap with first data associated with a said at least one unresolved dependency is detected. Completing the neural network processing for the task further comprises causing the execution unit to wait at an output write stage until the at least one unresolved dependency becomes resolved.

Described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor, optionally running a host operating system, supporting the simulator program. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor), some simulated embodiments may make use of the host hardware, where suitable.

The simulator program may be stored on a computer-readable storage medium (which may be a non-transitory medium), and provides a program interface (instruction execution environment) to the target code (which may include the applications, operating systems and hypervisor) which is the same as the application program interface of the hardware architecture being modelled by the simulator program. Thus, the program instructions of the target code, including the control of memory accesses based on the realm protection functionality described above, may be executed from within the instruction execution environment using the simulator program, so that a host computer which does not actually have the hardware features of the apparatus discussed above can emulate these features.

The methods in accordance with the present invention may be implemented at least partially using software e.g. computer programs. It will thus be seen that when viewed from further embodiments the present invention comprises computer software specifically adapted to carry out the methods herein described when installed on data processor, a computer program element comprising computer software code portions for performing the methods herein described when the program element is run on data processor, and a computer program comprising code adapted to perform all the steps of a method or of the methods herein described when the program is run on a data processing system.

The present invention also extends to a computer software carrier comprising such software which when used to operate a data processing system causes in a processor, or system to carry out the steps of the methods of the present invention. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the present invention need be carried out by computer software and thus from a further broad embodiment the present invention comprises computer software and such software installed on a computer software carrier for carrying out at least one of the steps of the methods set out herein.

The present invention may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

What is claimed is:

1. A data processing system, the data processing system comprising a processor that is configured to perform neural network processing, the processor comprising: at least one execution unit configured to perform processing operations for neural network processing; and a control circuit configured to distribute processing tasks to the at least one execution unit to cause the at least one execution unit to perform processing operations for neural network processing in response to a set of indications of neural network processing to be performed provided to the control circuit; wherein the processing tasks are asynchronous and comprise a dependency on at least one other processing task, the set of indications of neural network processing to be performed comprising an indication flag to indicate whether the execution unit can be caused to operate with a dependency on at least one other asynchronous processing task being unresolved.

2. The data processing system as claimed in claim 1, wherein the indication flag is comprised in a set of indications sent by the control circuit to multiple execution units, wherein the execution units are input readers and each input reader receives the indication flag in its set of indications.

3. The data processing system as claimed in claim 1, wherein an input reader is permitted to fetch second data where no overlap with first data associated with a said unresolved dependency is detected.

4. The data processing system as claimed in claim 1, wherein the execution unit caused to operate with a said unresolved dependency is provided with a signal after execution begins to indicate that the dependency has been resolved.

5. The data processing system as claimed in claim 1, wherein when data is fetched from storage to be processed by the neural network, the data is operable upon in accordance with a sequence of operations according to at least a portion of a graph representation of the neural network.

6. The data processing system as claimed in claim 5, wherein the execution unit caused to operate with a said unresolved dependency is further caused to wait when the graph reaches an output stage until said unresolved dependency is resolved.

7. The data processing system as claimed in claim 5, wherein the portion is represented by a sub-graph of the graph representation of the neural network.

8. The data processing system as claimed in claim 5, wherein connections between sections in the graph representing the neural network are pipes and are mapped to storage elements in the processor.

9. The data processing system as claimed in claim 8, wherein the control unit is configured to control and dispatch work representing an operation of the graph on at least a portion of the data provided by a pipe when the required data for the operation is stored in the pipe.

10. The data processing system as claimed in claim 1, wherein an execution unit is operable to perform a memory load access to initiate a sequence of operations according to at least a portion of a graph representation of the neural network.

11. A method of operating an execution unit of a processor that is configured to perform neural network processing, the method comprising:
receiving a task and a set of indications of neural network processing to be performed;
detecting from at least a first indication flag in the set of indications whether the neural network processing for the task can be started with at least one unresolved dependency at the execution unit;
detecting from at least a second flag which neural network processing work items of the task can be performed at the execution unit with at least one unresolved dependency;
performing the execution unit processing operations for neural network processing;
detecting when the at least one unresolved dependency becomes resolved; and
responsive to detecting when the at least one unresolved dependency becomes resolved, completing the neural network processing for the task.

12. The method as claimed in claim 9, further comprising receiving the set of indications including the indication flag at an input reader.

13. The method as claimed in claim 11, wherein receiving a set of indications comprises receiving at least a single bit indication flag.

14. The method as claimed in claim 11, further comprising permitting an input reader to fetch second data where no overlap with first data associated with a said at least one unresolved dependency is detected.

15. The method as claimed in claim 11, wherein completing the neural network processing for the task further comprises causing the execution unit to wait at an output write stage until the at least one unresolved dependency becomes resolved.

16. A method of data processing, the data processing method implemented by a processor that is configured to perform neural network processing, the method comprising: at least one execution unit processing operations for neural network processing; distributing processing tasks to the at least one execution unit to cause the at least one execution unit to perform processing operations for neural network processing in response to a set of indications of neural network processing to be performed; wherein the processing tasks are asynchronous and comprise a dependency on at least one other processing task, the set of indications of neural network processing comprising an indication flag indicating whether the execution unit can be caused to operate with a dependency on at least one other asynchronous processing task being unresolved.

17. A method as claimed in claim 16, wherein the execution units are input readers and each input reader is receiving the indication flag in its set of indications.

18. A method as claimed in claim 17, including fetching second data where no overlap with first data associated with a said unresolved dependency is detected.

19. A method as claimed in claim 16, including the execution unit operating with a said unresolved dependency is provided with a signal after execution begins to indicate that the dependency has been resolved.

20. A method as claimed in claim 18, including fetching data from storage to be processed by the neural network, the data is operable upon in accordance with a sequence of operations according to at least a portion of a graph representation of the neural network.
